(19) United States
(12) Patent Application Publication
(10) Pub. No.: US 2010/0157800 A1
(43) Pub. Date: Jun. 24, 2010

(54) METHOD FOR PROCESSING NETWORK TRAFFIC LOADING BALANCE

(75) Inventors: Gui-Dong Liu, Tianjin (CN); Tom Chen, Taipei (TW)

Correspondence Address: STEVENS & SHOWALTER LLP, 7019 CORPORATE WAY, DAYTON, OH, 45459-4238, US

(73) Assignee: INVENTEC CORPORATION, Taipei (TW)

(21) Appl. No.: 12/339,342

(22) Filed: Dec. 19, 2008

(51) Int. Cl. H04L 12/56

(52) U.S. Cl. 370/235

(57) ABSTRACT

A method for processing network traffic loading balance is adapted for balancing the load of a session of various data packet processing threads in a network equipment. The method includes the following steps. First, a plurality of data packet processing threads is executed, a queue is assigned to each thread for storing the received data packets, and the data packet is read from the queue by the thread for processing. Then, it is determined whether the number of the data packets in the queue satisfies a traffic threshold value. If the number of the data packets in a certain queue satisfies an operating threshold value, new data packets are allocated by the network equipment to other queues without affecting the integrity of the session. Therefore, the present method not only maintains the integrity of the session, but also ensures the uniformity in load among the data packet processing threads.

### BACKGROUND OF THE INVENTION

1. Field of the Invention

The present invention relates to a method for processing packets in a network, and more particularly to a method for processing network traffic loading balance.

2. Related Art

With the increasing growth of Internet, network transmission technology also develops quickly. Thus, many network equipments are added with the loading balance function. The loading balance for network transmission mainly refers to the network equipment assigning queues to store data packets and processing the packets with corresponding threads on receiving a large flow of data packets. The data packets are simultaneously processed by a plurality of threads to prevent the limitation of a single processing thread. Meanwhile, the accuracy of data packet processing is guaranteed by ensuring the integrity of the session.

However, the conventional loading balance still has disadvantages. FIG. 1 is a schematic architectural view of loading balance in the prior art. Though a plurality of threads and corresponding queues are arranged in the network equipment, the network equipment randomly assigns a queue for storing the data packets on receiving the data packets from different sources. With such a design, problems may occur when the network equipment is handling the data packets of the same session or fragmented data packets of the same group. As the data packets of the same session and fragmented data packets of the same group cannot be processed until all the data packets are received, the network equipment needs to retrieve from each queue if the data packets of the same session are stored in different queues. Thus, the performance of data packet processing is greatly degraded. What's worse, it is ultimately impossible for the network equipment to process the data packets from other sources when attacked by distributed denial of service (DDoS).

### SUMMARY OF THE INVENTION

In order to solve the above problems, the present invention is mainly directed to a method for processing network traffic loading balance so as to balance the load of a session of various threads in a network equipment.

Therefore, a method for processing network traffic loading balance is provided. The method includes the steps of: executing a plurality of threads each for processing the data packets of a session, and assigning a queue to each thread for storing the data packets; setting an operating threshold value; determining whether the number of the data packets in the queue satisfies the operating threshold value; and if the number of the data packets in the queue satisfies the operating threshold value, forwarding by a server the data packets in a queue to the other queues for storing according to a transmission attribute of the session.

The method for processing data packet loading balance provided by the present invention is used for preventing a large number of data packets from flowing into a single queue. Besides, in addition to maintaining the integrity of the session, the stability of packet processing is also ensured during a large traffic.

### BRIEF DESCRIPTION OF THE DRAWINGS

The present invention will become more fully understood from the detailed description given herein below for illustration only, which thus is not limitative of the present invention, and wherein:

FIG. 1 is a schematic architectural view of loading balance in the prior art;

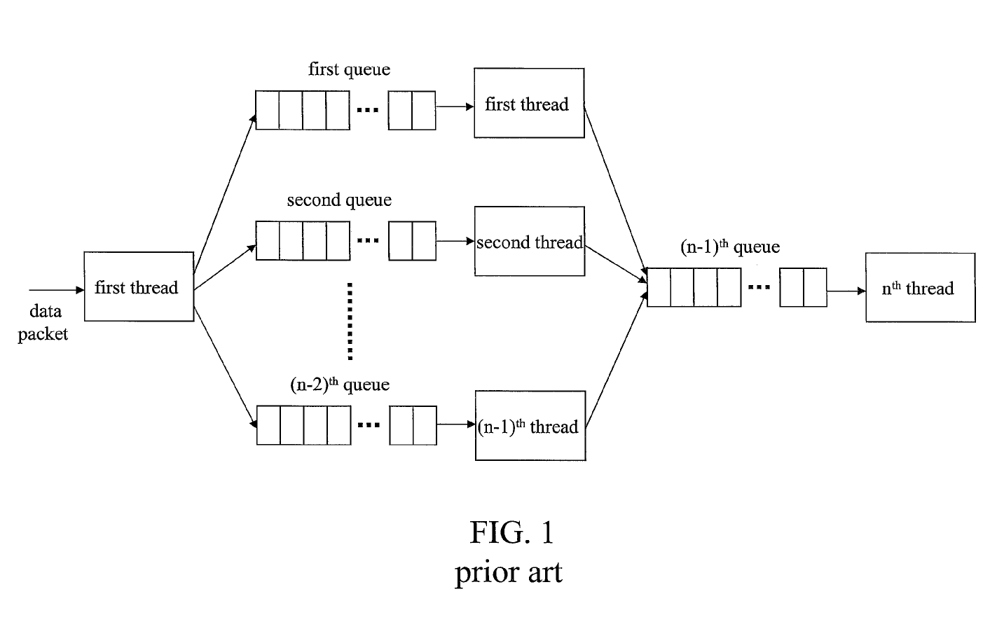

FIG. 2 is a schematic architectural view of the present invention;

FIG. 3A is a schematic flow chart showing the operation of the present invention;

FIG. 3B is a schematic flow chart of establishing a session lookup table;

FIG. 3C is a schematic flow chart of establishing a packet fragment lookup table;

FIG. 3D is a schematic flow chart of determining the storage of a data packet;

FIG. 4 is a schematic view showing the operation architecture of the present invention;

FIG. 5A is a schematic view showing the recording format of the session lookup table; and

FIG. 5B is a schematic view showing the recording format of the packet fragment lookup table.

### DETAILED DESCRIPTION OF THE INVENTION

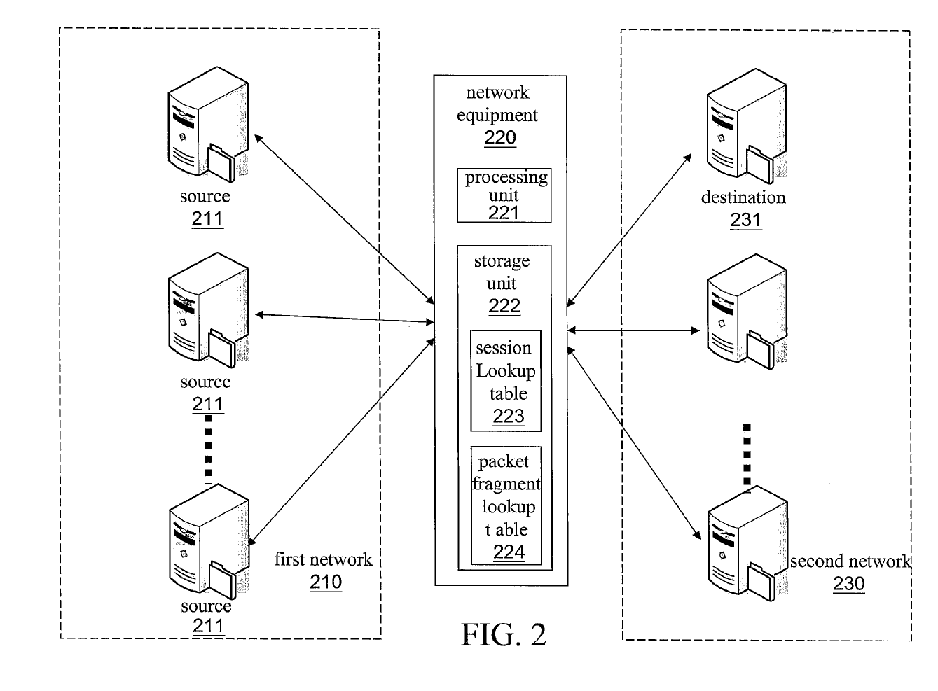

The present invention is applicable to a network equipment with packet exchange. The network equipment is, for example but not limited to, an intrusion detection system (IDS), firewall, and intrusion prevention system (IPS). FIG. 2 is a schematic architectural view of the present invention. In FIG. 2, a first network and a second network are connected to a switch. The first network 210 containing a plurality of sources 211 is shown on the left side of FIG. 2, and the second network 230 containing a plurality of destinations 231 is shown on the right side of FIG. 2. The network equipment 220 of the present invention includes a processing unit 221, a storage unit 222, a session lookup table 223, and a packet fragment lookup table 224. The storage unit 222 is used for storing the session lookup table 223 and the packet fragment lookup table 224. The processing unit 221 is used for detecting whether the currently received data packets belong to the same session according to the session lookup table 223. The processing unit 221 is used for detecting whether the currently received data packets are fragmented data packets of the same group according to the packet fragment lookup table 224.

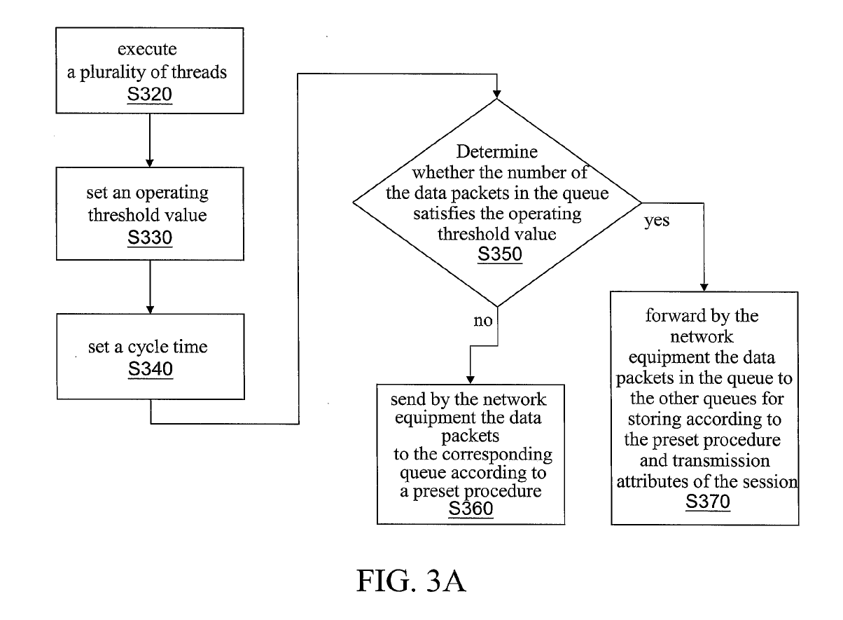

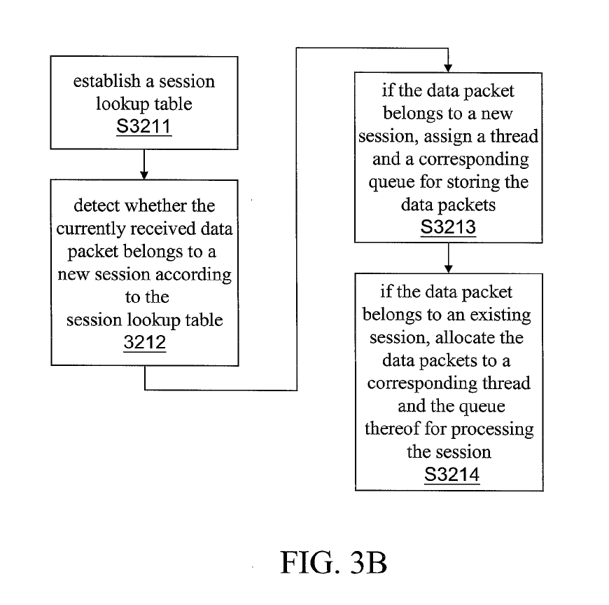

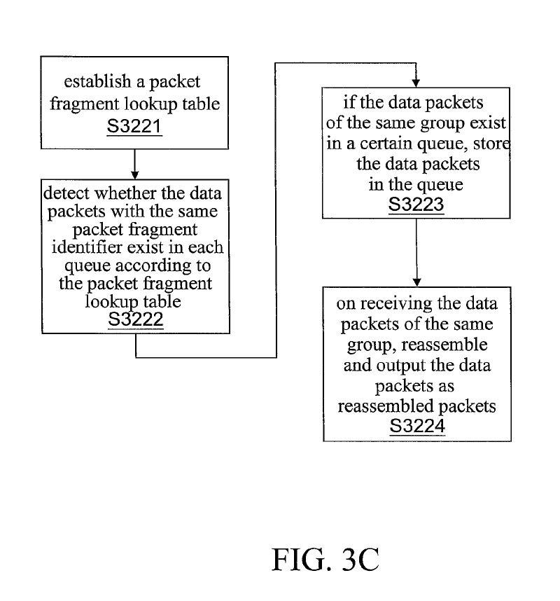

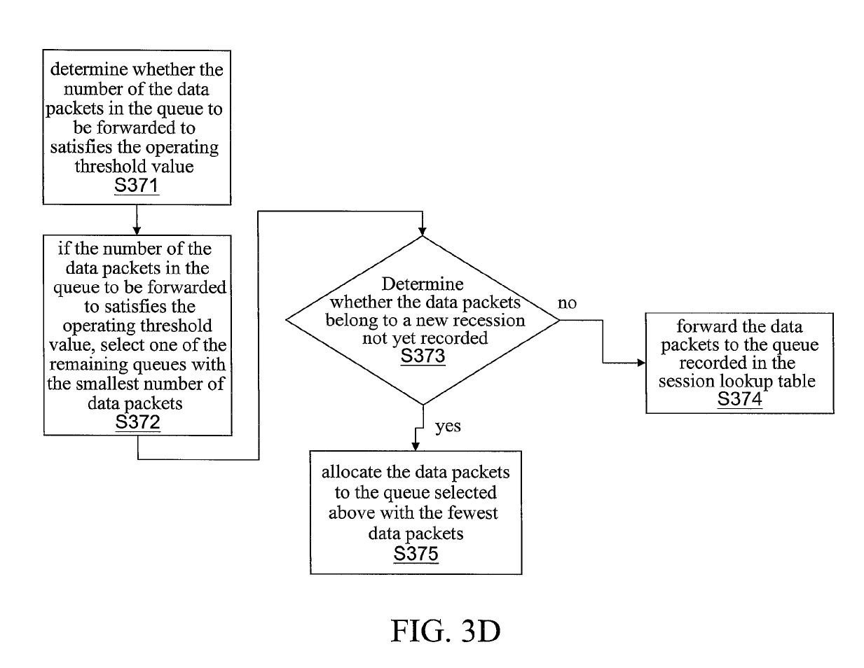

FIG. 3A is a schematic flow chart showing the operation of the present invention. After receiving the data packets from different sources 211, the network equipment performs corresponding service processing such as intrusion detection and virus detection on the data packets in the following steps. First, a plurality of threads is executed (Step S320), and a queue is assigned to each thread. The queue is used for storing the data packets, and each thread is used for processing the data packets of the session.

After the establishment of the session and the execution of the threads, the server establishes the session lookup table 223 and the packet fragment lookup table 224 respectively according to the received data packets. FIG. 3B is a schematic flow chart of establishing a session lookup table. The establishment of the session lookup table includes the following steps. A session lookup table is established (Step S3211) for recording the transmission attributes of each data packet. The transmission attributes include a source address, a destination address, a source transmission port, a destination transmission port, a transmission protocol, a session number, and a packet fragment identifier. According to the session lookup table, it is detected whether the currently received data packet belongs to a new session (Step S3212). If the data packet belongs to a new session, a thread and a corresponding queue are assigned for storing the data packets (Step S3213). If the data packet belongs to an existing session, the data packet is forwarded to the corresponding thread and the queue thereof for processing the session (Step S3214).

FIG. 3C is a schematic flow chart of establishing a packet fragment lookup table. The establishment of the packet fragment lookup table includes the following steps. A packet fragment lookup table is established (Step S3221). As the amount of data bearable for a data packet is limited, the source 211 will fragment the data in advance in accordance with the data amount of the data packet, and then sequentially fill the fragmented data into each data packet. In order to clearly describe the data packets of the same batch, the data packets are further defined as in the same group. Next, according to the packet fragment lookup table, it is detected whether the data packets with the same packet fragment identifier exist in each queue (Step S3222). If the data packets of the same group exist in a certain queue, the data packets are stored in the queue (Step S3223). After being received, the data packets of the same group are reassembled and output as reassembled packets (Step S3224).

Following Step S320, an operating threshold value is set (Step S330) for determining whether the queue is able to store more currently received data packets. The operating threshold value is set according to the relative proportion between the number of the data packets in the queue and the maximum volume of the queue. For example, if the queue is capable of containing 100 data packets and the queue has already received 70 data packets, the volume of the queue is defined as 70/100=70%. Assume that the operating threshold value is 60%, and the above volume of the queue has exceeded the threshold. Afterward, a cycle time is set (Step S340) to determine a time interval for the network equipment to detect the number of the data packets in each queue. Then, it is determined whether the number of the data packets in the queue satisfies the operating threshold value (Step S350).

If the number of the data packets in the queue has not reached the operating threshold value, the network equipment sends the data packets to the corresponding queue according to a preset procedure (Step S360). If the number of the data packets in the queue satisfies the operating threshold value, the network equipment forwards the data packets in the queue to the other queues for storing according to the preset procedure and the transmission attributes of the session (Step S370). In this embodiment, the preset procedure selects the queue to be forwarded to according to Equation 1 below:

Q_num=(src_IP&0×FF)+(dst_IP&0×FF)% n+1 (Equation 1)

In the equation, Q_num is the number of the destination queue to be forwarded to, scr_IP is the IP address of a source, dst_IP is the LP address of a destination, and n is the number of the queues.

Further referring to FIG. 3D, other steps are included following Step S360. It is determined whether the number of the data packets in the queue to be forwarded to satisfies 25 the operating threshold value (Step S371). If yes, one of the remaining queues with the smallest number of data packets is selected (Step S372). By looking up in the session lookup table and the packet fragment lookup table, it is determined whether the data packet belongs to a new session that has not yet been recorded (Step S373). If the data packet belongs to an existing session, the data packet is forwarded to a queue recorded in the session lookup table (Step S374). If the data packet belongs to a new session, the data packet is allocated to the queue selected above with the fewest data packets (Step S375), and meanwhile the records for the session are added in the session lookup table. Finally, after the cycle time, the network equipment selects the queue with the largest number of the data packets, and Step S350 is performed on the subsequently received data packets.

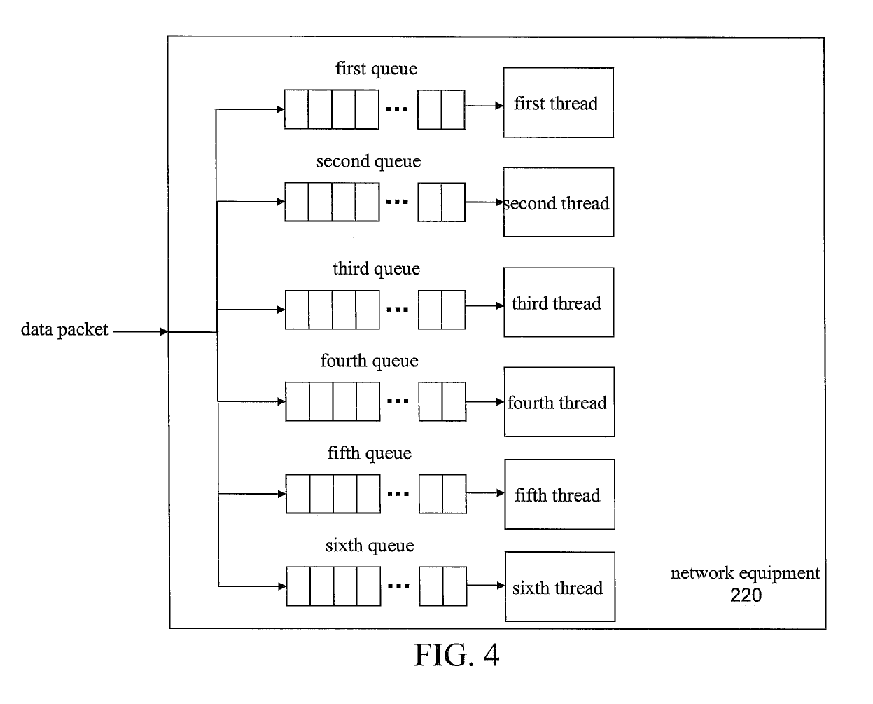

The following example is given to clearly describe the operating process of the present invention. FIG. 4 is a schematic view showing the operation architecture of the present invention. It is assumed herein that the operating threshold value is 70%, and six sessions and corresponding queues (a first queue, a second queue, a third queue, a fourth queue, a fifth queue, and a sixth queue) are established in the network equipment. The network equipment 220 receives data packets from the sources respectively, and the data related to the source 211 is src_ip: 218.30.108.184, src_port: 80. All the received data packets are transmitted to the destination 231, and the data related to the destination 231 is dst_ip: 10.190.50.39, dst_port: 2048. After starting to receive the data packets, the network equipment 220 obtains a queue to which the data packet is to be forwarded for storing according to Equation 1. Further, referring to Equation 2 below:

((218.30.108.184)&0×FF+(10.190.50.39)&0×FF)% 6+1=2 (Equation 2)

After the cycle time, the data packet volume of each queue in the network equipment is stated in Table 1 as follows:

TABLE 1
Data packet volume of each queue

Queue number

| | 1 | 2 | 3 | 4 | 5 | 6 |
|---|---|---|---|---|---|---|
| Volume | 80% | 65% | 65% | 50% | 40% | 20% |

Seen from Table 1, the volume of the first queue has exceeded the operating threshold value. Therefore, when receiving a new data packet (defined herein as a first data packet), the network equipment 220 selects another queue for storing the first data packet. It is assumed that the source of the first data packet is src_ip: 223.40.106.183, src_port: 80, and the destination thereof is dst_ip: 10.190.50.39, dst_port: 3000.

If the first data packet belongs to a new session, the network equipment 220 calculates the queue for storing the first data packet according to Equation 1. Equation 3 is given as follows:

((223.40.106.183)&0×FF+(10.190.50.39)&0×FF) % 6+1=1 (Equation 3)

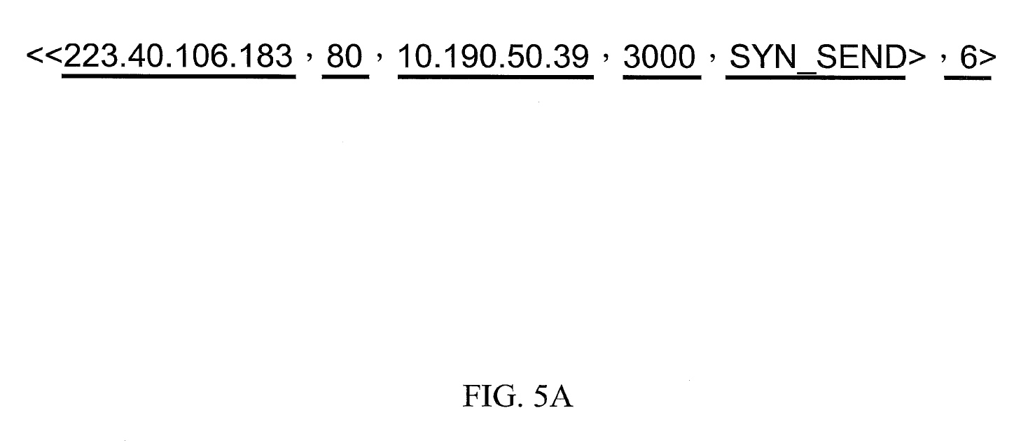

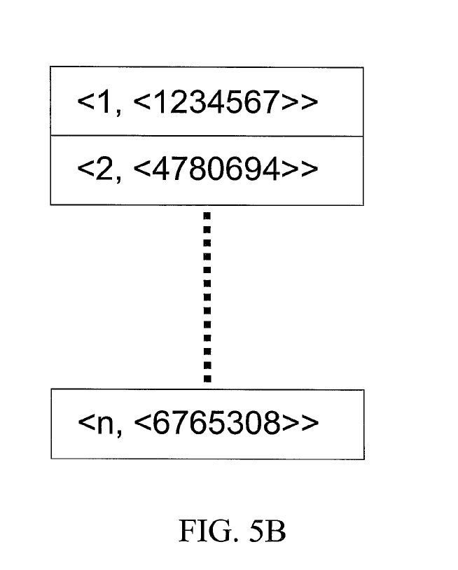

According to Equation 3, it is derived that the first data packet is to be stored in the first queue. However, as the first queue has exceeded the operating threshold value, the network equipment 220 selects one from the other queues with the lowest volume. Seen from Table 1, the sixth queue has the lowest volume at present. Therefore, the network equipment 220 stores the first data packet in the sixth queue. Moreover, the network equipment 220 records related information about the first data packet in the session lookup table 223. For the ease of description, the session lookup table 223 of this embodiment adopts the following recording format. FIG. 5A is a schematic view showing the recording format of the session lookup table.

When receiving a second and a third data packet with a fragment identifier of the same group, the network equipment 220 stores the second and the third data packet to the sixth queue according to the context of the first data packet, and records the second and the third data packet in the packet fragment lookup table 224. Assume that the fragment identifier is “1234567”, and the packet fragment table is as shown in FIG. 5B. Then, the network equipment 220 checks the queue for storing the received data packets according to the session lookup table 223 and the packet fragment lookup table 224.

The method for processing data packet loading balance provided by the present invention is used for preventing a large number of data packets from flowing into a single queue. Besides, in addition to maintaining the integrity of the session, the stability of packet processing is also ensured during a large traffic.

What is claimed is:

1. A method for processing network traffic loading balance, adapted for balancing the load of a session of a plurality of data packet processing threads in a network equipment, the method comprising:
executing a plurality of threads each for receiving the session, and assigning a queue to each thread for storing the data packets;
setting an operating threshold value;
determining whether the number of the data packets in the queue satisfies the operating threshold value; and
if the number of the data packets in the queue satisfies the operating threshold value, forwarding by the network equipment the data packets in the queue to the other queues according to a transmission attribute of the session.

2. The method for processing network traffic loading balance according to claim 1, wherein after executing the threads, the method further comprises:
establishing a session lookup table for recording the transmission attributes of each data packet;
detecting whether the currently received data packet belongs to a new session according to the session lookup table; and
if the data packet belongs to the new session, assigning the thread and the corresponding queue for storing the data packets.

3. The method for processing network traffic loading balance according to claim 1, wherein after executing the threads, the method further comprises:
establishing a packet fragment lookup table;
detecting whether the data packets with the same packet fragment identifier exist in each queue according to the packet fragment lookup table; and
if the data packets from the same group exist in the queue, storing the data packet in the queue.

4. The method for processing network traffic loading balance according to claim 3, wherein after storing the data packet in the queue, the method further comprises:
on receiving the data packets, reassembling and outputting the data packets as reassembled packets.

5. The method for processing network traffic loading balance according to claim 1, wherein the forwarding of the data packets to the other queues is determined by the following equation:
Q_num=(src_IP&0×FF)+(dst_IP&0×FF)% n+1
where Q_num is the number of the queue to be forwarded to, scr_IP is the IP address of a source, dst_IP is the IP address of a destination, and n is the number of the queues.

6. The method for processing network traffic loading balance according to claim 5, wherein after obtaining the queue to be forwarded to, the method further comprises:
if the number of the data packets in the queue to be forwarded to reaches the operating threshold value, one of the remaining queues with the smallest number of the data packets is selected; and
forwarding the data packet to the queue selected above with the fewest data packets.

7. The method for processing network traffic loading balance according to claim 1, wherein after forwarding the data packets to another queue, the method further comprises:
setting a cycle time;
after the cycle time, selecting the queue with the largest number of the data packets; and
determining whether the number of the data packets in the queue satisfies the operating threshold value.

8. The method for processing network traffic loading balance according to claim 1, wherein the transmission attributes comprise a source address, a destination address, a source transmission port, a destination transmission port, a transmission protocol, a number of the session, and a packet fragment identifier.
